(19) United States
(12) Patent Application Publication
(10) Pub. No.: US 2012/0235474 A1
(43) Pub. Date: Sep. 20, 2012

(54) WINDSHIELD EMBEDDED POWER COIL FOR WIRELESS CHARGING

(76) Inventors: Joseph Mannino, Bloomfield Hills, MI (US); Thomas A. Miller, Royal Oak, MI (US); Roy Thorsell, Royal Oak, MI (US)

(21) Appl. No.: 13/232,427

(22) Filed: Sep. 14, 2011

Related U.S. Application Data
(60) Provisional application No. 61/382,865, filed on Sep. 14, 2010.

(51) Int. Cl. B60L 1/00

(52) U.S. Cl. 307/10.1

(57) ABSTRACT

A wireless power charging or supply system provides a wireless charging coil mounted on or in a vehicle windshield. The wireless charging coil is positioned so that an electronic device that is mounted to the vehicle windshield will receive power from the wireless charging coil.

This application claims priority to U.S. Provisional Application Ser. No. 61/382,865, filed Sep. 14, 2010.

### BACKGROUND

Wireless charging of electronic devices via induction is becoming more standard. Induction chargers typically use an induction coil to create an alternating electromagnetic field. A second induction coil in the electronic device takes power from the electromagnetic field and converts it back into electrical current to charge the battery. Electronic devices can be charged or powered via induction without direct electrical conductive contact. There are several standards, including Qi, but any wireless or inductive power supply or charging could be used in the present invention.

Many people are using portable GPS units that are mounted to a vehicle windshield via a suction cup. In order to provide power to the GPS unit, cords hang down from the GPS unit, drape over the instrument panel and connect to power point. The dangling cord is a potential distraction and presents an undesirable appearance.

### SUMMARY

A wireless power charging or supply system according to one embodiment of the present invention provides a wireless charging coil mounted on or in a vehicle windshield. The wireless charging coil is positioned so that an electronic device that is mounted to the vehicle windshield will receive power from the wireless charging coil.

### BRIEF DESCRIPTION OF THE DRAWINGS

FIG. 1 shows a wireless charging system according to one embodiment of the present invention installed in a vehicle windshield.

FIG. 2 is a side view of the system and vehicle windshield of FIG. 1.

FIG. 3 is an enlarged view of the charging coil of FIG. 1.

### DETAILED DESCRIPTION OF THE PREFERRED EMBODIMENT

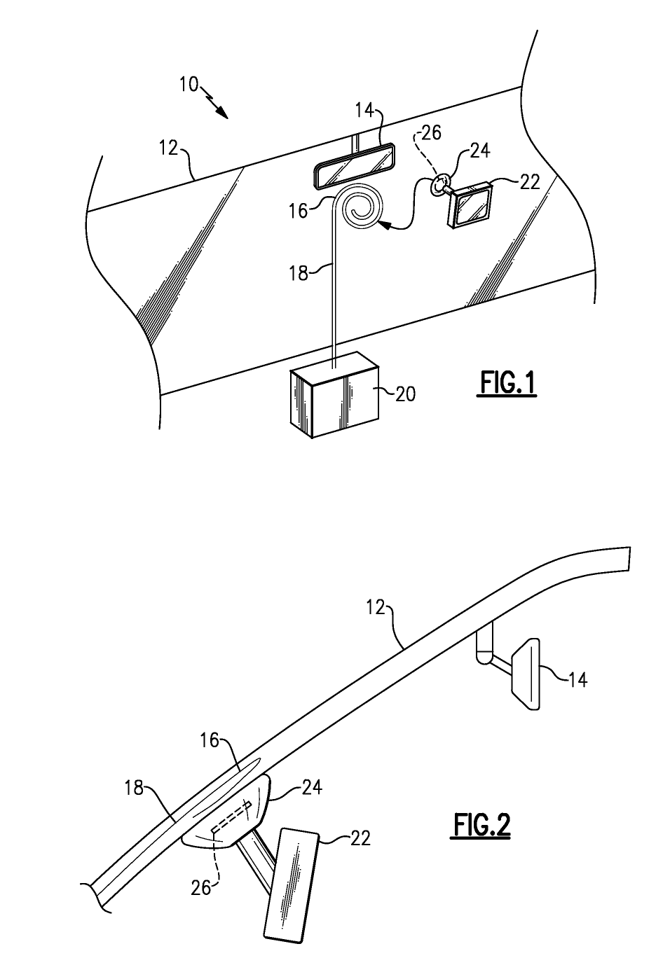

A wireless charging/power system 10 according to one embodiment of the present invention is shown in FIGS. 1 and 2. A vehicle windshield 12 and rearview mirror 14 are shown in FIGS. 1 and 2. A thin wire 18 is embedded in the windshield 12 and runs from a power source 20 to an area below the rearview mirror 14 where the wire 18 is formed into a coil 16. The wire 18 could run up from the power source 20 in the instrument panel, or could run down to the coil 16 from the headliner and rear view mirror 14 mounting hardware. The power source 20 provides current to the coil 16 according to any of the wireless power/charging standards. The power source 20 may be a simple AC power source generating an AC current at the frequency according to the appropriate standard. The coil 16 is also formed according to the appropriate wireless power/charging standard. The wire 18 is thin, such as the radio antennas that are sometimes mounted in or on windshields. The wire 18 may be embedded in a layer in the windshield 12 or formed on a surface of the windshield 12, such as some electric rear window defrost wires.

A GPS unit 22 (or any other electronic device) can be mounted to the windshield 12 via a suction cup 24 in a known manner. However, in this suction cup 24 is provided a coil 26, which is configured appropriately to receive power from the coil 16 mounted in the windshield 12 according to the appropriate standard. When the GPS unit 22 is mounted to the windshield 12, the power is provided from the power source 20 through the wire 18 and coil 16 via induction to the coil 26 to the GPS unit 22. This eliminates the need for any wires or cords dangling from the GPS unit 22.

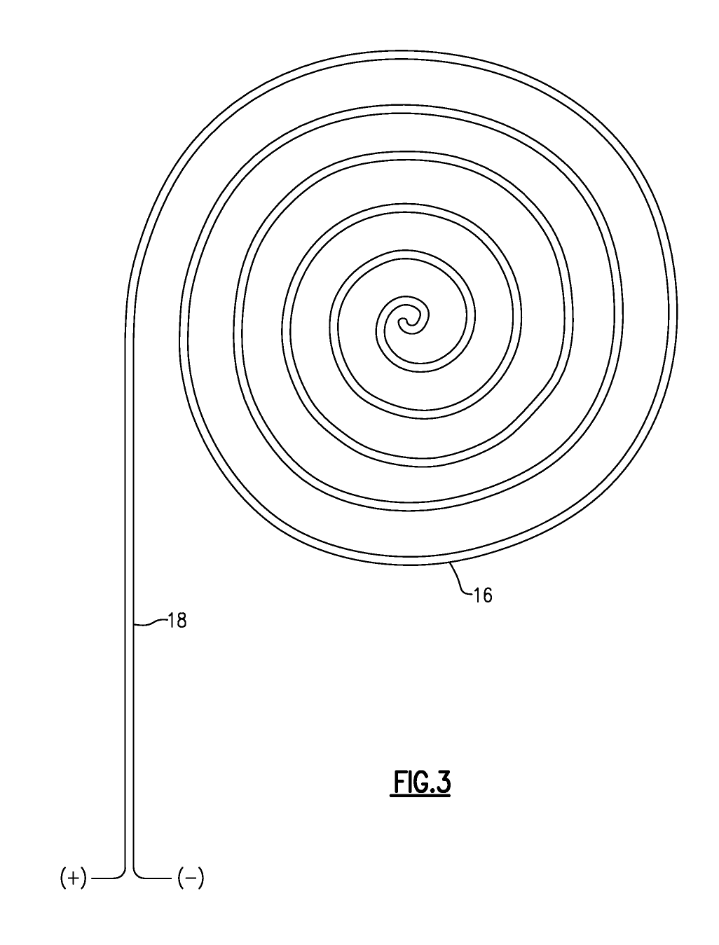

Referring to FIG. 3, the wire 18 is a single wire that is formed into a coil 16 in one direction until it reaches the center and then turns back on itself in the opposite direction, parallel to the first coil until both wire ends return to the edge of the windshield 12 (not shown in FIG. 3). FIG. 3 is somewhat schematic, as the particular arrangement of the coil 16 may depend upon the particular standard being used.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope. For example, an electronic device other than a GPS unit 22 could be mounted to the windshield (or possibly, placed on the dash immediately below the coil 16) and powered by the coil 16, such as a radio, portable media player, smartphone, display, light, etc.

What is claimed is:

1. A wireless power supply including:
a coil mounted to a vehicle windshield; and
a power source connected to the coil.

2. The wireless power supply of claim 1 wherein the power source is an AC power source, such that the coil provides the ability to wirelessly provide power to an electronic device with a complementary coil.

3. The wireless power supply of claim 2 wherein the coil is mounted inside the vehicle windshield.

4. The wireless power supply of claim 2 in combination with an electronic device mounted to the windshield proximate the coil.

5. The wireless power supply and electronic device of claim 4 wherein the coil is a first coil and wherein the electronic device includes a second coil for receiving power from the first coil.

6. The wireless power supply and electronic device of claim 5 wherein the electronic device includes a suction cup for mounting to the windshield.

7. The wireless power supply and electronic device of claim 6 wherein the second coil is mounted in the suction cup.

8. The wireless power supply and electronic device of claim 6 wherein the electronic device includes a GPS receiver powered by the second coil.

9. The wireless power supply of claim 1 wherein the coil is mounted inside the vehicle windshield.

10. A method for charging an electronic device including the steps of:
a) placing an electronic device proximate a power coil mounted to a vehicle windshield, the electronic device including a receiving coil for receiving power wirelessly from the power coil; and
b) causing the power coil to wirelessly transmit power to the receiving coil to power or charge the electronic device.

11. The method of claim 10 wherein said step a) includes the step of securing the electronic device to the windshield.

12. The method of claim 11 wherein the step of securing includes the step of securing the electronic device to the windshield with a suction cup.
